(19) United States
(12) Patent Application Publication
(10) Pub. No.: US 2014/0159923 A1
(43) Pub. Date: Jun. 12, 2014

(54) Elastic Clustering of Vehicles Equipped with Broadband Wireless Communication Devices

(71) Applicant: CISCO TECHNOLOGY, INC., San Jose, CA (US)

(72) Inventors: Rajeev Koodli, Saratoga, CA (US); Arjun Prasanna Athreya, Palo Alto, CA (US); Anand Oswal, Pleasanton, CA (US)

(73) Assignee: CISCO TECHNOLOGY, INC., San Jose, CA (US)

(21) Appl. No.: 13/708,399

(22) Filed: Dec. 7, 2012

(51) Int. Cl. G08G 1/0967

(52) U.S. Cl. CPC G08G 1/0967
USPC 340/905

(57) ABSTRACT

The techniques described herein provide mechanism that allows a Vehicular Communication Systems (VCSs) server, e.g., a cluster server, or other network attached device to group or cluster a set of vehicles into a multicast group according to common mobility characteristics shared by the set of vehicles. For example, the set of vehicles may be in close proximity to each other and are traveling on the same road, or share a common destination. Information pertinent to the cluster, can be broadcast to the multicast group in lieu of traditional individual unicast messages that would typically be sent to each vehicle.

### TECHNICAL FIELD

The present disclosure relates to grouping vehicular mobile communications devices according to their common mobility characteristics.

### BACKGROUND

Vehicular Communication Systems (VCSs) are a type of wireless network in which vehicles and roadside units exchange information such as traffic information and safety alerts. In some implementations, the communicating nodes, e.g., the vehicles and roadside units, are Dedicated Short Range Communications (DSRC) devices that operate in the 5.9 gigahertz (GHz) band. In other implementations, wireless broadband may be employed. The DSRC nodes exchange information such as position and traffic information, and may be part of an Intelligent Transportation System (ITS). For example, the ITS may use vehicle positions and speed to make “intelligent” decisions that adjust traffic signal timing to reduce traffic congestion or to provide alternate routes to the vehicle operator.

Whether wireless broadband or DSRC wireless communications links are employed, the links are vehicle device specific or unicast in nature. As the number of vehicles serviced by a VCS network increases over time, the load on the roadside units and the associated central servers increase accordingly. The increased load, e.g., during rush hour, may cause network latency, overload, or other unwanted effects. Accordingly, as new vehicles are added to the VCS network, the network may not scale efficiently.

### BRIEF DESCRIPTION OF THE DRAWINGS

FIG. 1 is a system level diagram showing vehicles grouped into multicast clusters and serviced by a cluster server according the techniques described herein.

FIG. 2 is an example flow diagram of a process used to generate two types of traffic bottleneck modeling data from a set of vehicle traffic data that can be used to group vehicles into multicast clusters.

FIG. 3 is an example flow diagram that illustrates a process for determining whether a bottleneck will occur for vehicles in a cluster.

FIG. 4 is an example 3-dimensional histogram for bottleneck prediction based on traffic modeling data.

FIG. 5 is an example of a block diagram of a cluster server depicted in FIG. 1.

FIG. 6 is an example flow diagram of a general process used to group vehicles into multicast clusters.

### DESCRIPTION OF EXAMPLE EMBODIMENTS

### Overview

The embodiments described herein provide mechanism that allows a VCS server, e.g., a cluster server, or other network attached device to group a set of vehicles into a multicast group according to common mobility characteristics shared by the set of vehicles. For example, the set of vehicles may be in close proximity to each other and/or are traveling on the same road, and/or share a common destination.

Mobility parameters are received from a plurality of vehicles at a network device, e.g., a cluster server. The mobility parameters are analyzed in order to determine whether a subset of the plurality of vehicles can be clustered based on common mobility parameters of the subset of vehicles. The subset of vehicles is clustered into a multicast group when it is determined that the subset of vehicles can be clustered based on the common mobility parameters of the subset of vehicles. Information, e.g., information pertinent to the cluster, is broadcast to the multicast group corresponding to the common mobility parameters of the subset of vehicles.

### Example Embodiments

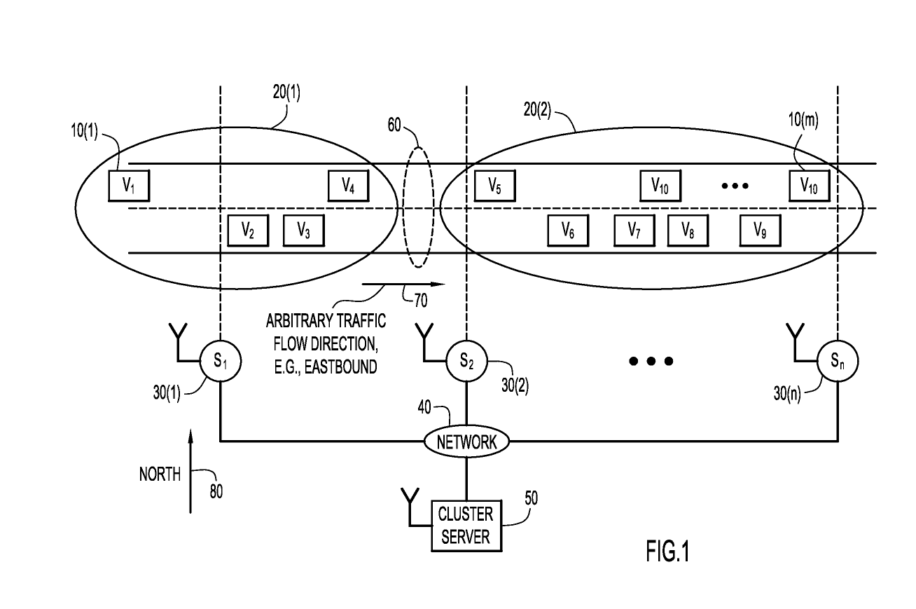

Referring first to FIG. 1, a system level block diagram is shown comprising mobile devices V₁-Vₘ enumerated as 10(1)-10(m), wireless stations or access points S₁-Sₙ enumerated as 30(1)-30(n), a network 40, and a service provider or cluster server 50. The mobile devices 10 may be, e.g., a mobile phone or laptop computer, or a broadband device embedded in a vehicle to obtain services provided via network 40 from a service provider associated with cluster server 50. In this example, the vehicles V₁-Vₘ are moving along a two lane roadway 60 of an otherwise larger highway (not depicted). The vehicles V₁-Vₘ are moving in a common direction 70, e.g., Eastbound, in a North-up map orientation 80, and therefore share at least one common mobility characteristic in that the mobile devices V₁-Vₘ are all moving in the same direction.

In this example, mobile devices V₁-V₄ are grouped into cluster 20(1) while mobile devices V₅-Vₘ are grouped into cluster 20(2). In this example, the vehicles in cluster 20(2) are between station S₂ and station Sₙ, and grouped together for one of any number of reasons based on their mobility parameters. For example, the vehicles in cluster 20(2) may be grouped by virtue of being between stations S₂ and Sₙ, in that they share a common destination at some point beyond Sₙ, or that Sₙ is a common intermediate destination for all of the vehicles in cluster 20(2). In this regard, all of the vehicles V₁-Vₘ are considered to have access to services provided via stations S₁-Sₙ, i.e., they have login or other handshake access, or are subscribers to those services.

In one example, a service provider such as AT&T™ or VERIZON™ will provide services by way of stations S₁-Sₙ. Such services may include traffic reports to the vehicle's destination or to an intermediate destination. Such traffic reports may take into account what is “normal” traffic for a particular time of day, such as midnight traffic or rush hour traffic. In cases such as during rush hour, normal traffic flow may be 35 miles per hour (MPH), while at midnight, traffic may flow at the speed limit, e.g., 60 MPH. Thus, rush hour traffic flowing at 35 MPH may be reported as normal and anything less than 35 MPH would be considered to be some form of relative traffic congestion. Additional details determining whether congestion will occur are described hereinafter.

In another example, traffic on roadway 60 may be at a standstill or the vehicle's occupants may be looking for a bank or restaurant. Under such circumstances, the service provider may provide location based services to the vehicles, e.g., the vehicle's onboard system may display Bank A (exit 5), Bank B (exit 7), restaurants D, E, and F (exit 6). Should the user select one of the listed options, e.g. via a touch screen, the onboard system may then provide directions.

One issue that service providers face, absent the clustering mechanism described herein, is that each vehicle, V₁-Vₘ, is considered an individual entity in that wireless traffic exchanged between the vehicles and the stations are unicast. Unicast messaging requires that information common to all vehicles, e.g., traffic reports, be sent individually to each vehicle. As the number of subscribers continues to grow, this system is forced to scale linearly with the number of subscribers. However, by virtue of the techniques described herein, clustered vehicles may be formed into multicast groups according to their mobility characteristics. For example, the vehicles in cluster 20(2) may received common traffic reports and a single multicast traffic report can be broadcast as a single message to all vehicles in cluster 20(2). It should be understood that vehicles may be grouped into more than one cluster, e.g., a vehicle may be part of one multicast group for traffic reports and may be part of another multicast group for receiving restaurant type and location notifications. A multicast group may also be referred to as a service group that indicates a common service or common information that a group would be “interested” in.

Furthermore, it should be understood that vehicles do not have to be between stations such as those vehicle depicted in cluster 20(2) between stations S₁-Sₙ. Vehicle V₁ in cluster 20(1) is not depicted as being between stations, although the possibility exists that another station may be West of V₁, as viewed in the figure. Vehicles may be clustered by mobility attributes or parameter in lieu of location such as common subscription requests, e.g., banking, shopping, or dining requests. Accordingly, the actual position of the vehicle may not be a factor in such clustering.

Thus, the “always-on” mobile broadband as well as other sensory telemetry communication facilitates vehicle clustering according to the techniques described herein. In such a paradigm, the always-on mobile broadband connection is used for providing a variety of services including traffic updates as the consumers drive their automobiles through highways and other roads. Forming user clusters for common information dissemination is radio frequency (RF) bandwidth and network resource saving since groups of users share common traffic traits, such as common highway exits, traffic jams, carpool lanes, and so on.

A traffic or cluster server 50, suitably placed in a metropolitan (metro) data center for instance, is able to dynamically form such user clusters as the traffic dynamics change on a highway at different hours of the day, and is further equipped to dynamically re-cluster such vehicle groups or other mobile device groups into multicast groups. To facilitate such multicast groups, Internet Group Management Protocol (IGMP) may be employed along with or in lieu of other suitable grouping protocols, e.g., some environments may implement Protocol Independent Multicast (PIM) or variations thereof. Embodiments described herein provide for elastically or dynamically forming user clusters for traffic or mobility information dissemination as a function of the actual vehicular traffic and/or user needs. The same techniques may be employed in other environments such as shopping malls or subway stations, where user may be conveniently clustered for optimum resource utilization.

In some embodiments, the IGMP notation of (S, G) may be used, where S is the multicast stream source Internet Protocol version 6 (IPv6) address and G is the multicast group IPv6 address. Any upper layer protocol module, i.e., an always on vehicle system module enabled protocol, that has joined or otherwise subscribed to (*, G), where * indicates subscribed IGMP source (S) address, will receive the G addressed datagrams, i.e., each (*, G) socket receives the stream. In this example, * may indicate a wildcard address which may be used with the techniques described herein. IGMP notation, as used herein, is known in the art.

In order to facilitate certain mobility situations, a mobility handoff message may be employed when a mobile unit transitions from one station to another. For example, as part of mobile network design, each station, e.g., each of S₁-Sₙ, may have a different controller unit or system controller (not shown). The handoff messages employed between stations may include transition information from one controller to another, e.g., cluster server 50, and another server which may also conveniently act as the controller for network 40. In this regard network 40 may also refer to stations and servers associated with the network 40, and another controller may also control or interact with network 40 and includes other stations and cluster servers.

Accordingly, messages within network 40 between controllers may include information that may be used to identify network control information for individual vehicles and their transition from one server to another. For example, a mobility handoff message may include information comprising a Virtual Local Area Network (VLAN) identifier (ID), a unique network ID (e.g., a bridge domain ID), and a link-local multicast group address (G)). In this regard, clusters may be VLANs as a matter of design or convenience. Messages may be based on information such that, controllers or servers, e.g., server 50 and another server, or controller, data may include clustering, grouping, and/or multicast information.

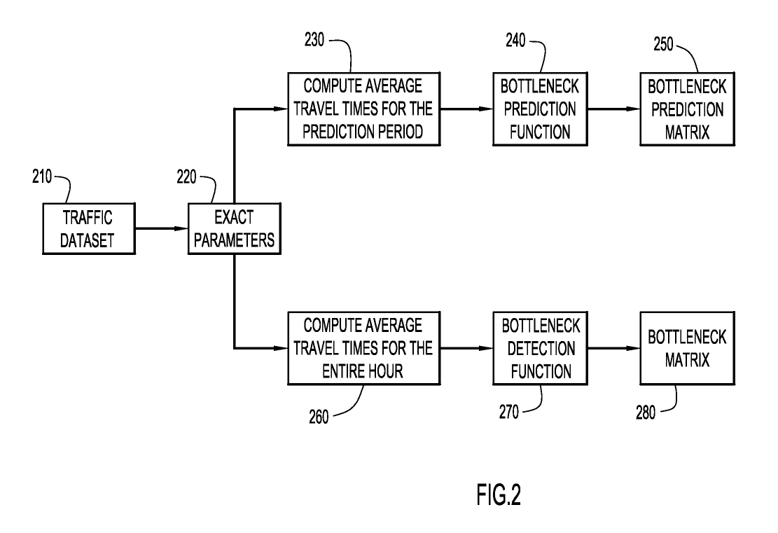

Referring now to FIG. 2, a simplified flow diagram is shown for a process used to generate two of types traffic bottleneck modeling data from a set of vehicle traffic data that can be used to group vehicles into multicast clusters. At 210, a traffic dataset is obtained or generated. The dataset 210 may be composed of historical traffic data, current real-time traffic data, or both. Historical data may be obtained from various government agencies such as the United States Department of Transportation (USDOT) or the California Department of Transportation (Caltrans) which keep historical data for planning purposes.

The traffic data set 210 is processed by a central processing system or distributed among cluster servers, e.g., cluster server 50. Accordingly, the traffic data set 210 may be preprocessed and distributed to cluster servers according to the locations of the wireless stations that they serve. Thus, the cluster or traffic server 50 receives data from traffic sources such as highway traffic information sources and non-traffic sources, e.g., geographic location information such as banks, malls, restaurants, etc. The traffic server also receives input from various vehicle occupants or other mobile users who enter their interests, e.g., a destination or other geographic request such as “XYZ” bank or “PDQ” restaurant. The output of the traffic server is traffic information sent via mobile network to subscribing users. The traffic information ranges from highway/roadway conditions such as average travel time between arbitrary stations of interest to any interesting geo-location information associated with those stations.

At 220, parameters of interest are extracted from dataset 210. In this example traffic data for each RF access point, e.g., sites S₁-Sₙ, are extract based on the geographic locations of the respective sites. At 260, the parameters 220 are processed to compute an average travel time on a per hour basis while at 230 the parameters 220 are processed on a more granular level to compute an average travel time for a period of interest, e.g., quarter-hours or multiples of one or more minutes. The averages computed at 230 and 260 may be for both historical and real-time data. At 240, the averaged data 230 are processed according to a bottleneck prediction function. The term “bottleneck,” as used herein, refers to the general concept of a narrowed passageway that generally turns into a traditional traffic jam or other form of traffic congestion, and is not meant to be a limiting term, but a conceptual one in order to facilitate the reader's grasp of the embodiments presented herein.

At 270, the averaged data 260 are processed according to a bottleneck detection function. It should be noted that any appropriate bottleneck prediction and/or detection function may be employed for purposes of clustering according to the techniques described herein. Specific examples of such functions are provided in detail hereinafter. By virtue of the bottleneck prediction function 240, the data are loaded into a bottleneck prediction matrix 250 according to the granularity of the prediction period described above. Similarly, bottleneck detection function 270 data are loaded into a bottleneck matrix 280 for an hourly time period. One or both of bottleneck prediction matrix 250 or bottleneck matrix 280 may be used to cluster vehicles 10 (FIG. 1) or other mobile users into multicast groups, and as per this example on the basis of traffic flow prediction. The matrices 250 and 280 contain relative congestion data, e.g., scaled or normalized values, e.g., from zero to one, or other relative values such as low, medium, or high congestion for the given input conditions.

In one example, the traffic server 50, or other processing entity coupled to network 40, first computes a traffic profile for any two arbitrary pairs of stations, e.g., stations that may be conveniently associated with exits on a highway, and based on the available sources of information as described above. This traffic profile indicates whether a station pair has a relatively congested or smooth flow of traffic. The vehicle's on-board system may be equipped with Global Positioning System (GPS), Galileo, Global Navigation Satellite System (GLONASS), or other geo-location system that supplies the traffic server 50 with the coordinates of the vehicle, e.g., latitude, longitude, and altitude. Other location systems may be employed that use, e.g., RF signal strength or other signal processing solutions.

The traffic server 50 creates clusters of users who are subscribed to the computed traffic profiles for sending traffic information via the mobile network 40. The clusters may be based on a destination, intermediate destination, or other mobility parameters that a group of users share. The traffic server 50 may first generate a cluster for vehicular traffic between a pair of stations, e.g., S₁ and S₂, experiencing higher than normal associated traffic flow. The traffic server 50 sends a computed traffic profile to the cluster, which in turn, can be translated into information that a user can digest, e.g., a graphical display of the traffic flow and associated travel time estimates. The normal traffic load may be computed based on the historical and/or actual average travel times between the given pair of stations. It should be noted that traffic data can be computed for a single station using only the position data provided by the mobile device. However, existing historical data are provided between a pair of stations and it becomes convenient to use station pairs when incorporating historical data into the techniques described herein.

The cluster of users may then receive the computed and localized traffic updates for the pairs of stations along the intended route using a multicast message. The multicast receiver membership may depend on the number of vehicles or automobiles experiencing a particular traffic flow. For example, a multicast group corresponding to one or more pairs of stations with associated traffic congestion will likely have larger number of users that can be clustered to form a single multicast group, thereby reducing the overall communication system requirements.

In another example, a cluster may be created for a traffic between consecutive pairs of stations experiencing a relatively smooth traffic flow. Such a cluster can cover a larger geographic distance on a highway or roadway since the traffic flow is not congested. In such situations a multicast group may cover “all” areas of non-congestion, i.e., any vehicle not experiencing potential traffic congestion can be sent an “all clear” multicast group message that indicates that no traffic congestion is to be expected for the particular geographic region or route. As such, the requirements on the mobile communication system are reduced by aggregating larger number of subscribers for those types of traffic updates.

As described in connection with FIG. 2, the traffic server computes congestion predictions based on the historical empirical data, as well as instantaneous or real-time data. The traffic server 50 analyzes the long-term data (spanning, e.g., a month) for average and standard deviations of travel time and uses the instantaneous data to predict any potential traffic bottlenecks. When the traffic server 50 detects a congestion bottleneck, the traffic server automatically creates a new cluster or updates an existing cluster, and sends a multicast traffic update message to all of the subscribers in the cluster.

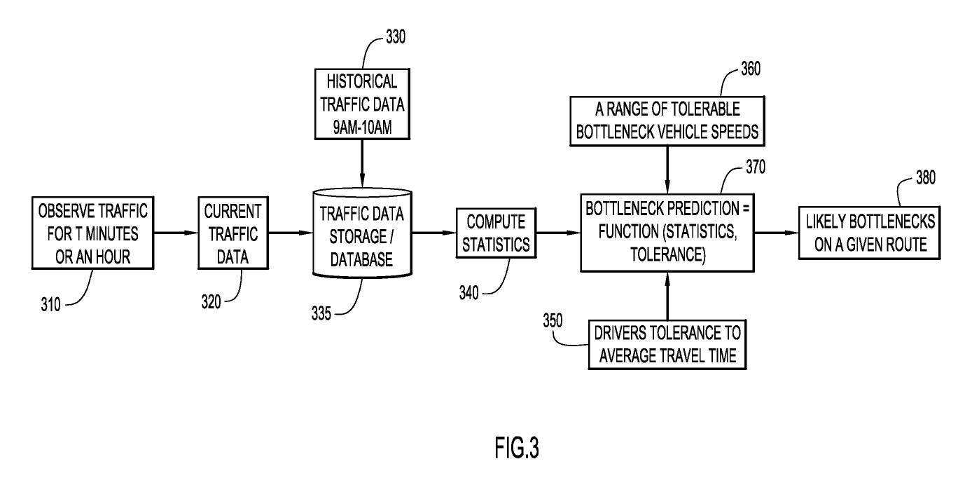

Referring to FIG. 3, an example flow diagram that illustrates a process for determining whether a bottleneck will occur for vehicles in a cluster is now described. At 310, traffic is observed for a predetermined period of time, T, e.g., one hour or a portion thereof. From the traffic observations, at 320, current or near-current traffic data are obtained. At 340, the current traffic data 320 are used along with historical data 330, e.g., data from 9 am to 10 am for the period observed at 310, to compute relevant statistics that may be used for traffic bottleneck prediction.

At 350, a heuristic approach to the average driver's tolerance for a current travel time relative to an average travel time for a particular time of day is determined or estimated, as will be explained later. At 360, a range of tolerable bottleneck speeds is determined. It should be noted that any given driver's tolerance for time or speed may be based on the traffic a driver expects for a given time period. In other words, a driver may have a greater tolerance for delay or slow traffic speeds that are expected during rush hour. At 370, the computed statistics 340, travel time tolerance 350, and bottleneck speed 360 are fed to a bottleneck prediction function. At 380, the output of function 370 determines whether or not bottlenecks are likely on a given route or on a station by station basis, e.g., between any two stations or access points S₁-Sₙ.

In one example of the prediction function, the traffic server uses the following computations for determining the potential bottleneck. A prediction interval is defined as a fraction of the hour used to study the vehicular traffic at the beginning of a given hour, e.g., as shown in the upper branch of FIGS. 3, at 230, 240, and 250; the average predicted travel time, TP_{AVG}, is the travel time between two consecutive points of interest on a road during the prediction interval; the average travel time, TH_{AVG}, is the travel time between two consecutive points of interest on a road during the entire hour of interest; the average speed during prediction interval, SP_{AVG}, is the average speed of vehicles between two consecutive points of interest on a road during the prediction interval; the average speed during an hour, SH_{AVG}, is the average speed of vehicles between two consecutive points of interest on a road during the prediction interval; and the standard deviation in travel time, TPσ, is the standard deviation in travel time between two consecutive points of interest on a road, which considers historical data for the same hour between the same two consecutive points on the road. Further a human bottleneck tolerance factor, ƒ, is defined which is a factor that represents the average travel time between two consecutive points of interest on a road that a user is willing to wait in order to view a slower travel time as a bottleneck. The value for ƒ, may be from one to two at increments that produce results with a desired granularity. A speed of interest, SI, is a range of driving speeds humans are willing to classify as bottleneck speeds.

According to the above definitions a bottleneck prediction function may be defined as:

TP_{AVG}+2×TPσ>=ƒ×TP_{AVG} OR SP_{AVG} is in the range of SI (Eq. 1)

A bottleneck detection function may be defined as:

(TH_{AVG}+2×THσ>=ƒ×TH_{AVG} AND TH_{AVG}>=distance/legal speed limit) OR SH_{AVG} in the range of SI, (Eq. 2)

where the terms “OR” and “AND” are Boolean algebraic logic terms that may be interpreted according to their plain meaning, i.e., one OR the other and both one AND the other

By way of example, for the start of each hour, vehicular traffic is observed on each stretch of interest on the highway for a time period referred to as the prediction study period. The average travel time of the vehicles for the stretch of the highway during the prediction study period is computed. The standard deviation of the observed data and the historical traffic performance data for the same hour are computed. The history can be nullified or zeroed out if a prediction is being performed for the first time, or the history could be truncated to as many days as are currently available and stored on a storage facility associated with the traffic server.

Similar computations may be performed for the metrics after the traffic has been monitored for the entire hour for which bottleneck was being predicted, e.g., as shown in the lower branch of FIGS. 2, at 260, 270, and 280. In this regard, the expression “ƒ×TP_{AVG}” serves as a threshold for travel time on a stretch of highway a user can tolerate as a normal driving time. Beyond this value, a user may treat this traffic situation as a bottleneck. The expression “TP_{AVG}+2×TPσ” is used to monitor travel time at the 2^{nd} standard deviation, i.e., a 95% confidence interval. In other words, the left hand side (LHS) of Equations 1 and 2, provide a range for which ˜95% of the values are in the normal distribution for the travel time for that hour. If the computed travel time is greater than the tolerable travel time, then it can be assumed that a bottleneck exists. The design of the prediction function is shown in FIG. 3.

The expression (TH_{AVG}>=distance/legal speed limit) is used in the bottleneck detection function to ensure that the average travel time is less than the travel time expected, when cruising at the legal speed limit on the highway. The reason for this check point is to determine whether a traffic pattern should be flagged as a bottleneck when the traffic is actually clearing after the prediction interval/distance according to Eq. 2. In the bottleneck detection function, Eq. 2, the 95^{th} percentile value of the travel time distribution is greater than the tolerable travel time on a stretch of the highway AND also ensures that the average travel time is still greater than the travel time for speeds greater than equal to the legal speed limit. A bottleneck is also detected if the speeds of vehicles are in the range of speed of interest indicating certain slow moving traffic.

In the prediction function, Eq. 1, the 95th % value of the travel time distribution is greater than the tolerable travel time on a stretch of the highway, i.e., TP_{AVG}+2×TPσ>=ƒ×TP_{AVG}. A bottleneck is also predicted if the speeds of vehicles are in the range of speed of interest indicating certain slow moving traffic. A second logical check condition, i.e., TH_{AVG}>=distance/legal speed limit, is not needed in the prediction function, Eq. 1, due to the possibility that while the first value, e.g., TP_{AVG}+2×TPσ>=ƒ×TP_{AVG}, may still be true due to slower traffic constituting of some of the momentarily slow moving vehicles, while the remaining majority of the vehicles are still traveling at a speed higher than the speed limit. In such circumstances, a bottleneck may or may not occur.

As an example, the traffic telemetry information of interest during the bottleneck period is the data pertinent to the events and progress of traffic until the bottleneck clears. In contrast, the traffic telemetry information of interest for smooth flowing traffic is the data pertinent to the next set of exits on the highway until a bottleneck is experienced. The smooth flowing traffic progresses to the next section of the highway, e.g., to the next set of stations, and vehicle occupants can still receive updates for the next several stretches of the highway whether or not a bottleneck is up and coming.

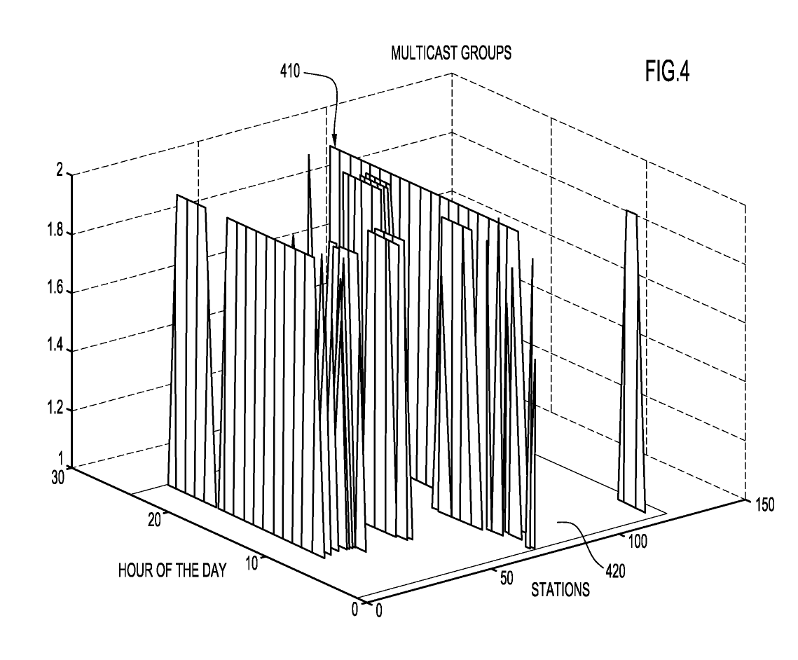

Accordingly, if a stretch of a highway is predicted to experience a bottleneck, then the vehicles are treated as one multicast group, whereas if a number of consecutive stretches are not expected to experience a traffic bottleneck, the mobile units may be treated as another multicast group for receiving traffic updates. An example output for predicted bottleneck from a MATLAB simulation using the techniques described herein is shown in FIG. 4. The data are for a stretch of U.S. Highway 101N in the state of California for Jul. 2, 2012.

On one horizontal axis the time of day is depicted for a 24 hour clock, while the other horizontal axis indicates station identifiers, e.g., for stations S₁-Sₙ, as viewed in FIG. 1. In this example, multicast groups are formed geographically according to vehicles serviced by various groups of stations. The vertical axis is normalized from one to two. At 410, when the multicast group has a vertical axis value of two, a bottleneck is predicted. At 420, when the multicast group has a vertical axis value of one, a bottleneck is not predicted. When providing vehicular traffic updates to the mobile users, a bottleneck prediction or lack thereof may be used to cluster subscribers into multicast groups. Such a decision model may assume the data are processed at the same time for a fixed prediction time period.

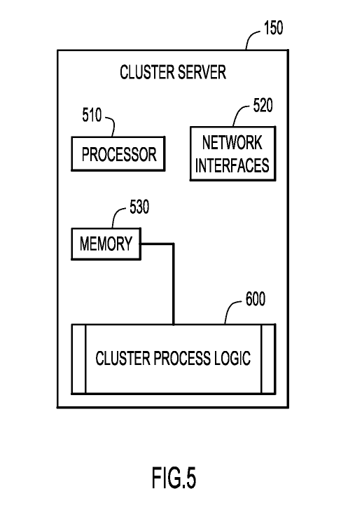

Turning now to FIG. 5, an example of a block diagram of a traffic or cluster server, e.g., cluster server 50 from FIG. 1, is now described. The diagram of FIG. 5 is representative of the general structure of any of network device, e.g., as described in connection with FIG. 1. Cluster server 50 comprises a processor 510, memory 530, and a network interface device(s) or unit(s) 520 (e.g., wireline network and RF interfaces). The network interface device 520 sends and receives packets from the various user devices, e.g., vehicles V₁-Vₘ, using the RF interface. Accordingly, interface device 520 may employ wireless local area network (WLAN) or wireless wide area network (WWAN) technology, e.g., 3G, 4G, EDGE, LTE, etc., and may also employ standard wired Ethernet network connectivity as depicted by the direct connection to the network 40 as viewed in FIG. 1. The processor 510 is, for example, a microprocessor, microcontroller, digital signal processor or other similar data processor configured for embedded applications in a switch.

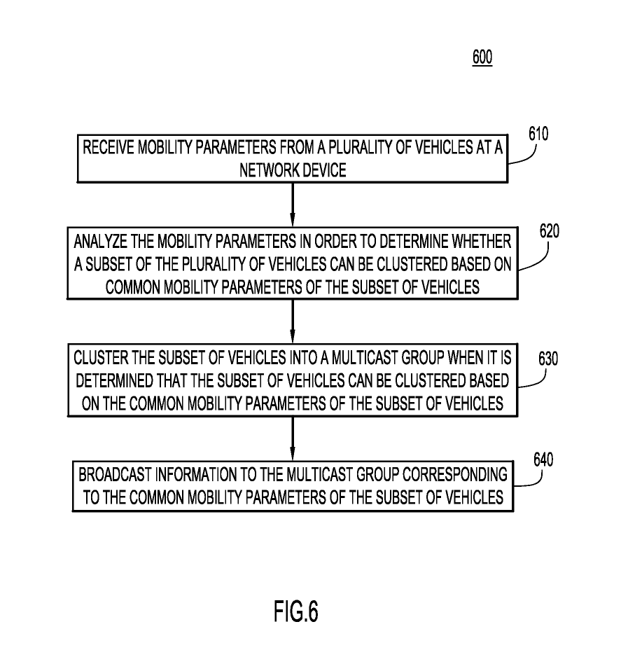

The memory 530 may comprise read only memory (ROM), random access memory (RAM), magnetic disk storage media devices, optical storage media devices, flash memory devices, electrical, optical, or other physical/tangible (non-transitory) memory storage devices. The memory 530 stores executable software instructions for mobile unit cluster process logic 600 that cluster mobile units or vehicles as described herein. Thus, the memory 530 may comprise one or more computer readable storage media encoded with software comprising computer executable instructions and when the software is executed operable to perform the operations described herein for the process logic 600. The processor 510 executes the process logic 600 in order to cluster mobile devices. Process logic has been described above in the context of specific examples and will be generally described in connection with FIG. 6.

Referring to FIG. 6, mobile unit cluster process logic 600 will now described. At 610, mobility parameters are received from a plurality of vehicles at a network device, e.g., cluster server 50. At 620, the mobility parameters are analyzed in order to determine whether a subset of the plurality of vehicles can be clustered based on common mobility parameters of the subset of vehicles. At 630, the subset of vehicles is clustered into a multicast group when it is determined that the subset of vehicles can be clustered based on the common mobility parameters of the subset of vehicles, and at 640, information pertinent to the cluster is broadcast to the multicast group corresponding to the common mobility parameters of the subset of vehicles.

The mobility parameters may comprise one or more of vehicle location, vehicle speed, vehicle destination, vehicle intermediate destination, and vehicle operator preferences. The mobility parameters may be received from the subset of vehicles via a plurality of intermediate receivers, e.g., stations S₁-Sₙ (FIG. 1), stationed at locations configured to provide travel segment information along a travel path to the subset of vehicles.

In another example, traffic parameters may be extracted from a traffic data set. The average travel times are computed for one or more predetermined prediction periods, and bottleneck prediction and bottleneck matrices may be generated from the average travel times using a bottleneck prediction and/or detection functions, e.g., as described in connection with FIG. 2.

Vehicular traffic can be observed for a predetermined time period and current traffic data is generated from the observed vehicular traffic. Bottleneck statistics are computed based on the current traffic data and corresponding historical data. A prediction can be made as whether a bottleneck will occur during a prediction period based on the computed bottleneck statistics. The technique may be further refined by determining a range of tolerable bottleneck vehicle speeds and a vehicle occupant's tolerance for an average travel time to a destination. The prediction whether the bottleneck will occur during the prediction period may be further based on one or more of the range of tolerable bottleneck vehicle speeds and the vehicle occupant's tolerance for an average travel time to a destination, e.g., as described in connection with FIG. 3.

The techniques described herein has the advantage that subscriber clusters can be created that map to a similar traffic profile on a given roadway and the cluster is provided relevant traffic or other information as a group, thereby reducing network load. These techniques enable an Application Service Provider (ASP) to host a range of transportation-related services for a range of subscriber clusters. Different clusters may be formed based on individual traffic or mobility characteristics (such as smooth moving traffic, bottlenecked traffic, traffic on carpool lane etc.), where each cluster receives different sets of services from the ASP.

The above description is intended by way of example only.

What is claimed is:

1. A method comprising:
receiving mobility parameters from a plurality of vehicles at a network device;
analyzing the mobility parameters in order to determine whether a subset of the plurality of vehicles can be clustered based on common mobility parameters of the subset of vehicles; and
clustering the subset of vehicles into a multicast group when it is determined that the subset of vehicles can be clustered based on the common mobility parameters of the subset of vehicles.

2. The method of claim 1, further comprising broadcasting information to the multicast group corresponding to the common mobility parameters of the subset of vehicles.

3. The method of claim 1, wherein receiving comprises receiving mobility parameters comprising one or more of vehicle location, vehicle speed, vehicle destination, vehicle intermediate destination, and vehicle operator preferences.

4. The method of claim 1, wherein receiving comprises receiving the mobility parameters from the subset of vehicles via a plurality of intermediate receivers stationed at locations configured to provide travel segment information along a travel path to the subset of vehicles.

5. The method of claim 1, further comprising:
extracting traffic parameters from a traffic data set;
computing average travel times for one or more predetermined prediction periods; and
generating a bottleneck prediction matrix from the average travel times using a bottleneck prediction function.

6. The method of claim 1, further comprising:
extracting traffic parameters from a traffic data set;
computing average travel times for one or more predetermined detection periods; and
generating a bottleneck matrix from the average travel times using a bottleneck detection function.

7. The method of claim 1, further comprising:
observing vehicular traffic for a predetermined time period;
generating current traffic data from the observed vehicular traffic;
computing bottleneck statistics based on the current traffic data and corresponding historical data; and
predicting whether a bottleneck will occur during a prediction period based on the computed bottleneck statistics.

8. The method of claim 7, further comprising:
determining a range of tolerable bottleneck vehicle speeds;
determining a vehicle occupant's tolerance for an average travel time to a destination; and
wherein predicting comprises predicting whether the bottleneck will occur during the prediction period based on one or more of the range of tolerable bottleneck vehicle speeds and the vehicle occupant's tolerance for an average travel time to a destination.

9. An apparatus comprising:
a network interface unit configured to enable network communications over a network;
a memory;
a processor coupled to the network interface unit and to the memory, wherein the processor is configured to:
receive mobility parameters from a plurality of vehicles via the network interface unit;
analyze the mobility parameters in order to determine whether a subset of the plurality of vehicles can be clustered based on common mobility parameters of the subset of vehicles; and
cluster the subset of vehicles into a multicast group when it is determined that the subset of vehicles can be clustered based on the common mobility parameters of the subset of vehicles.

10. The apparatus of claim 9, wherein the processor is further configured to broadcasting information to the multicast group corresponding to the common mobility parameters of the subset of vehicles.

11. The apparatus of claim 9, wherein the processor is further configured to receive comprises receiving mobility parameters comprising one or more of vehicle location, vehicle speed, vehicle destination, vehicle intermediate destination, and vehicle operator preferences.

12. The apparatus of claim 9, wherein the processor is further configured to:
extract traffic parameters from a traffic data set;
compute average travel times for one or more predetermined prediction periods; and
generate a bottleneck prediction matrix from the average travel times using a bottleneck prediction function.

13. The apparatus of claim 9, wherein the processor is further configured to:
extract traffic parameters from a traffic data set;
compute average travel times for one or more predetermined detection periods; and
generate a bottleneck matrix from the average travel times using a bottleneck detection function.

14. The apparatus of claim 9, wherein the processor is further configured to:
observe vehicular traffic for a predetermined time period;
generate current traffic data from the observed vehicular traffic;
compute bottleneck statistics based on the current traffic data and corresponding historical data; and
predict whether a bottleneck will occur during a prediction period based on the computed bottleneck statistics.

15. The apparatus of claim 14, wherein the processor is further configured to:
determine a range of tolerable bottleneck vehicle speeds;
determine a vehicle occupant's tolerance for an average travel time to a destination; and
wherein the processor is configured to predict whether the bottleneck will occur during the prediction period based on one or more of the range of tolerable bottleneck vehicle speeds and the vehicle occupant's tolerance for an average travel time to a destination.

16. One or more computer readable storage media encoded with software comprising computer executable instructions and when the software is executed operable to:
receive mobility parameters from a plurality of vehicles;
analyze the mobility parameters in order to determine whether a subset of the plurality of vehicles can be clustered based on common mobility parameters of the subset of vehicles; and
cluster the subset of vehicles into a multicast group when it is determined that the subset of vehicles can be clustered based on the common mobility parameters of the subset of vehicles.

17. The computer readable storage media of claim 16, wherein the computer executable instructions, when executed are further operable to broadcast information to the multicast group corresponding to the common mobility parameters of the subset of vehicles.

18. The computer readable storage media of claim 16, wherein the computer executable instructions, when executed are further operable to receive mobility parameters comprising one or more of vehicle location, vehicle speed, vehicle destination, vehicle intermediate destination, and vehicle operator preferences.

19. The apparatus of claim 9, wherein the processor is further configured to:
observe vehicular traffic for a predetermined time period;
generate current traffic data from the observed vehicular traffic;
compute bottleneck statistics based on the current traffic data and corresponding historical data; and
predict whether a bottleneck will occur during a prediction period based on the computed bottleneck statistics.

20. A method comprising:
receiving mobility parameters from a plurality of mobile user devices at a network device;
analyzing the mobility parameters in order to determine whether a subset of the plurality of mobile user devices can be clustered based on common mobility parameters of the subset of mobile user devices; and
clustering the subset of mobile user devices into a multicast group when it is determined that the subset of mobile user devices can be clustered based on the common mobility parameters of the subset of mobile user devices.
